(19) United States
(12) Patent Application Publication
(10) Pub. No.: US 2015/0063161 A1
(43) Pub. Date: Mar. 5, 2015

(54) RELAY DEVICE, COMMUNICATION SYSTEM, AND METHOD OF ACQUIRING NODE SETTING INFORMATION

(71) Applicant: ALAXALA NETWORKS CORPORATION, Kanagawa (JP)

(72) Inventors: Kazuaki HOMMA, Kawasaki (JP); Motohide NOMI, Kawasaki (JP)

(73) Assignee: ALAXALA NETWORKS CORPORATION, Kanagawa (JP)

(21) Appl. No.: 14/263,360

(22) Filed: Apr. 28, 2014

(30) Foreign Application Priority Data
Aug. 27, 2013 (JP) 2013-175262

(51) Int. Cl. H04W 48/14

(52) U.S. Cl. CPC H04W 48/14
USPC 370/254

(57) ABSTRACT

A relay device connected to a node and connects the node to a network, wherein, when receiving an address acquisition request through a physical port, the relay device transmits, to the node, an address acquisition reply including an address to be set in the node, node information identifying the node that has transmitted the address acquisition request, and an address of the setting information storage device which is connected to the network and configured to store setting information of the node, transmits, to the setting information storage device, a setting information acquisition request which is transmitted with an address of the setting information storage device set as a destination and which includes the node information, and transmits, to the node, setting information which corresponds to the node information included in the setting information acquisition request and which is transmitted from the setting information storage device.

### CROSS-REFERENCE TO RELATED APPLICATIONS

This application claims the priority of the Japanese Patent Application No. 2013-175262, filed on Aug. 27, 2013, which is incorporated herein by reference in its entirety.

### BACKGROUND OF THE INVENTION

1. Field of the Invention

The present invention relates to a relay device that is connected to a node and connects the node to a network.

2. Description of the Related Art

In recent years, a wireless access point (wireless AP) is installed in companies, schools, hospitals, and the like, and introduction of a wireless LAN (Local Area Network) environment has progressed.

The wireless LAN eliminates the need to perform LAN cable wiring, thereby facilitating network construction and network change and increasing freedom of floor layout. Further, the wireless LAN allows operation requiring network access everywhere (one's desk, conference room, meeting spot, etc.) without discrimination. These advantages have accelerated the introduction of the wireless LAN environment.

Further, a rapid prevalence of devices that are not provided with a wired LAN port, such as a smartphone and a tablet terminal, increases the need for introduction of the wireless LAN environment in companies and the like.

Further, an increased interest in a BYOD (Bring Your Own Device) an increasing trend of employees bringing their own devices to work is also cited as background of the increase in the need for introduction of the wireless LAN environment, and it is estimated that the number of companies that introduce a wireless LAN-based Network increases.

However, there are many issues facing the introduction of the wireless LAN, and it is a fact that many companies are concerned about an increase in an operation and maintenance load during and after the introduction and about security.

In general, a company or the like itself purchases spare parts of the wireless AP and replaces the wireless AP with a new one as needed. Therefore, it is required that an administrator can perform the replacement of the wireless AP without special network knowledge. However, the administrator needs to initially set in the wireless AP download destination address information or the like which is required for automatically downloading setting information (configuration information). That is, complete zero-configuration is not realized, and thus the administrator is required to have network knowledge.

There is disclosed JP-2009-246414-A as a prior art relating to the present technical field. This describes “A configuration transmission method for transmitting configuration stored in a server connected to a WAN through a router to a terminal connected to a LAN, wherein the router acquires the configuration from the server through an external network, the terminal transmits a first command for address request through the LAN to the router when activated, the router transmits a second command including an initial setting instruction together with an address through the LAN to the terminal, and, when receiving the second command from the router through the LAN, the terminal transmits a third command requesting the configuration through the LAN to the router, and, when receiving the third command from the terminal through the LAN, the router transmits the configuration through the LAN to the terminal” (see Abstract).

### SUMMARY OF THE INVENTION

However, in the technology described in the JP-2009-246414-A, it is necessary to manually register an ID and a password for accessing an HTTP/HTTPS server in the terminal, that is, complete zero-configuration is not realized.

An object of the present invention is to provide a relay device capable of automatically performing initial setting of a node without the need of manual setting.

One typical example of the present invention is a relay device connected to a node and connecting the node to a network, the relay device being connected to a setting information storage device that stores setting information of the node through the network and having at least one physical port connected to the node, wherein when receiving an address acquisition request which is a request for acquiring an address to be set in the node from the node through the physical port, the relay device transmits, to the node, an address acquisition reply including the address to be set in the node, node information identifying the node that has transmitted the address acquisition request, and an address of the setting information storage device, transmits, to the setting information storage device, a setting information acquisition request which is a request that the node has transmitted to acquire setting information of the node and which includes the node information with the address of the setting information storage device set as a destination, and transmits, to the node, setting information which corresponds to the node information included in the setting information acquisition request and which is transmitted from the setting information storage device.

An effect obtained by representative aspects of the present invention disclosed in the specification is as follows. That is, there can be provided a relay device capable of automatically performing initial setting of the node.

Other objects, configurations, and advantages of the invention will become apparent from the following description of embodiments.

### BRIEF DESCRIPTION OF THE DRAWINGS

FIG. 1 is an explanatory view of a configuration of a network system according to a first embodiment of the present invention;

FIG. 2 is an explanatory view of a DHCP processing section according to first embodiment of the present invention;

FIG. 3 is an explanatory view of a wireless AP registration table according to the first embodiment of the present invention;

FIG. 4 is an explanatory view of a management server IP registration table according to the first embodiment of the present invention;

FIG. 5 is an explanatory view of a setting information management table according to the first embodiment of the present invention;

FIG. 6 is a sequence diagram of processing to be performed in the network system when the wireless AP according to the first embodiment of the present invention is replaced with a new one;

FIG. 7 is a format diagram of a DHCP packet according to the first embodiment of the present invention;

FIG. 8 is a flowchart of packet transfer processing to be executed by a packet relay device according to the first embodiment of the present invention;

FIG. 9 is an explanatory view of a DHCP processing section provided in a packet relay device according to a second embodiment of the present invention;

FIG. 10 is an explanatory view of a DHCP server according to the second embodiment;

FIG. 11 is a sequence diagram of processing to be performed in the network system when the wireless AP according to the second embodiment of the present invention is replaced with a new one;

FIG. 12 is a flowchart of packet transfer processing to be executed by the packet relay device according to the second embodiment of the present invention;

FIG. 13 is a flowchart of packet transfer processing to be executed by a DHCP server according to the second embodiment of the present invention;

FIG. 14 is an explanatory view of a DHCP processing section according to a third embodiment of the present invention;

FIG. 15 is a sequence diagram of processing to be performed in the network system when the wireless AP according to the third embodiment of the present invention is replaced with a new one; and

FIG. 16 is a flowchart of packet transfer processing to be executed by a packet relay device according to the third embodiment of the present invention.

### DESCRIPTION OF THE PREFERRED EMBODIMENTS

Embodiments of the present invention will be described below with reference to the drawings.

### First Embodiment

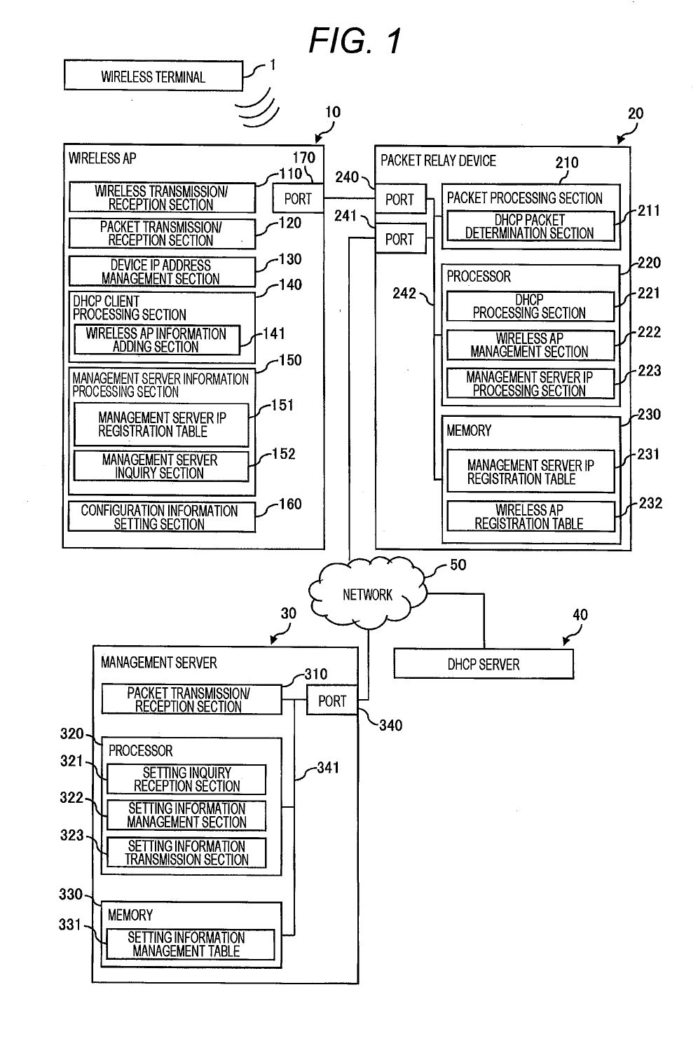

A first embodiment of the present invention will be described with reference to FIGS. 1 to 8.

FIG. 1 is an explanatory view of a configuration of a network system according to a first embodiment of the present invention.

The network system in the first embodiment 1 includes a wireless terminal 1, a wireless access point (wireless AP (node)) 10, a packet relay device (relay device) 20, a management server (setting information storage device) 30, and a DHCP (Dynamic Host Configuration Protocol) server 40 (address distributor).

The packet relay device 20, which is configured to connect a plurality of communication lines to each other, is connected to the wireless AP 10 and connected, through a network 50, to the management server 30 and DHCP server 40. The wireless AP 10 is a radio wave relay device connected by wireless to the wireless terminal 1 (e.g., a smartphone, a tablet terminal, etc.). The management server 30 stores setting information corresponding to the wireless AP 10 and transmits the setting information to the wireless AP 10 in response to a request from the wireless AP 10. The DHCP server 40 distributes an IP address and the like to the wireless AP 10.

First, the packet relay device 20 will be described.

The packet relay device 20 includes a packet processing section 210, a processor 220, a memory 230, and physical ports 240 and 241. The packet processing section 210, processor 220, memory 230, and physical ports 240, 241 are connected to each other through a bus 242 and the like.

The physical port 240 is connected to a physical port 170 provided in the wireless AP 10, and the physical port 241 is connected to the network 50 through a line. Unique identification information are given without overlaps to the physical ports 240 and 241, respectively, in the packet relay device 20, and thereby the physical ports 240 and 241 are uniquely identified by the given identification information. The physical port is hereinafter referred to merely as “port.” In the packet relay device 20, the physical ports 240 and 241 are each used as a port to which a single independent line is connected.

The packet processing section 210 executes packet processing that determines a physical port to which a packet received by the packet relay device 20 is transmitted. The packet processing section 210 has a DHCP packet determination section 211. The DHCP packet determination section 211 determines whether or not the packet received by the packet relay device 20 is a DHCP packet. A DHCP is a protocol that automatically assigns necessary information such as an IP address to various devices. Although the packet processing section 210 illustrated in FIG. 1 is implemented in hardware, it may be implemented in software.

The processor 220 executes various programs and includes a DHCP processing section 221, a wireless AP management section 222, and a management server IP processing section 223.

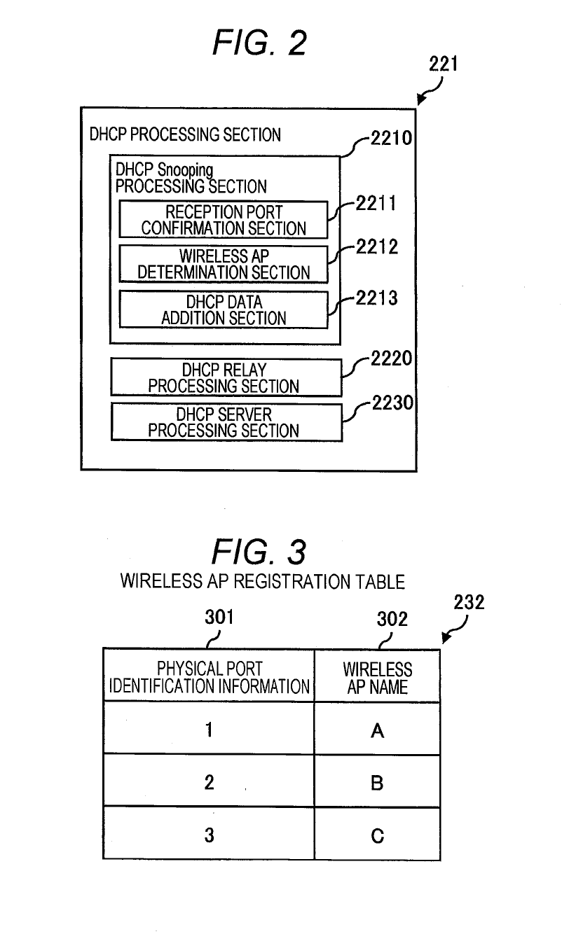

The DHCP processing section 221 executes DHCP processing. Details of the DHCP processing section 221 will be described later using FIG. 2. The wireless AP management section 222 manages a relationship between the physical port and wireless AP 10 connected to the physical port. The management server IP processing section 223 manages an IP address (address information) of the management server 30 that stores the setting information of the wireless AP 10.

The DHCP processing section 221, wireless AP management section 222, and management server IP processing section 223 are each implemented when the processor 220 executes a program corresponding thereto.

The memory 230 is a storage area for storing various programs that the processor 220 executes and data that the processor 220 reads therefrom or writes thereto. The memory 230 stores a management server IP registration table 231 and a wireless AP registration table (node information management information) 232.

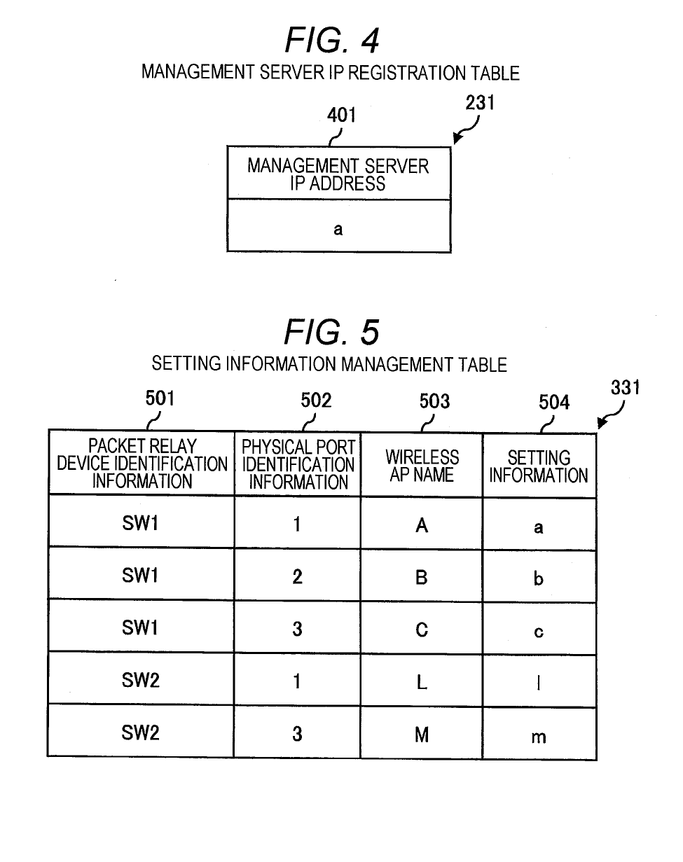

The IP address of the management server 30 is registered in the management server IP registration table 231, and the management server IP registration table 231 is referred to by the management server IP processing section 223. Details of the management server IP registration table 231 will be described later using FIG. 4. A correspondence between the identification information of the physical port and a wireless AP name (node information) that identifies the wireless AP to be connected to the physical port is stored in the wireless AP registration table 232. Details of the wireless AP registration table 232 will be described later using FIG. 3.

The following describes the wireless AP 10. The wireless AP 10 includes a wireless transmission/reception section 110, a packet transmission/reception section 120, a device IP address management section 130, a DHCP client processing section 140, a management server information processing section 150, and a configuration information setting section 160.

The wireless transmission/reception section 110 receives by wireless a signal transmitted from the wireless terminal 1 and transmits a signal by wireless to the wireless terminal 1. The packet transmission/reception section 120 receives a packet transmitted from the packet relay device 20 and transmits a packet to the packet relay device 20. The device IP address management section 130 manages the IP address of the wireless AP 10 distributed from the DHCP server 40.

The DHCP client processing section 140 executes processing relating to the DHCP packet transmitted/received between itself and DHCP server 40. The DHCP client processing section 140 has a wireless AP information adding section 141. When the DHCP client processing section 140 transmits the DHCP packet to the DHCP server 40, the wireless AP information adding section 141 adds wireless AP identification information indicating that the wireless AP 10 is a DHCP client to the DHCP packet.

The management server information processing section 150 registers the IP address of the management server 30 that stores the setting information of the wireless AP 10 in a management server IP registration table 151 and acquires the setting information from the management server 30. The management server information processing section 150 includes the management server IP registration table 151 and a management server inquiry section 152.

The IP address of the management server 30 is registered in the management server IP registration table 151. The management server inquiry section 152 transmits a setting information acquisition request to the management server 30 and receives the setting information from the management server 30.

The configuration information setting section 160 executes setting processing for the wireless AP 10 based on the setting information acquired from the management server 30.

The DHCP server 40 distributes necessary information such as address information to the DHCP client by using the DHCP.

The following describes the management server 30. The management server 30 stores the setting information of the packet relay device 20 and wireless AP 10 and distributes the setting information to the packet relay device 20 and wireless AP 10.

The management server 30 includes a packet transmission/reception section 310, a processor 320, a memory 330, and a physical port 340. The packet transmission/reception section 310, processor 320, memory 330, and physical port 340 are connected to each other through a bus 341.

The packet transmission/reception section 310 transmits/receives a packet through the network 50.

The processor 320 executes various programs and includes a setting inquiry reception section 321, a setting information management section 322, and a setting information transmission section 323. The setting inquiry reception section 321 receives the setting information acquisition request transmitted from the wireless AP 10. The setting information management section 322 manages the setting information corresponding to the wireless AP 10 and searches for setting information corresponding to the setting information acquisition request received by the management server 30. The setting information transmission section 323 transmits to the wireless AP 10 the setting information corresponding to the setting information acquisition request received by the management server 30.

The setting inquiry reception section 321, setting information management section 322, and setting information transmission section 323 are each implemented when the processor 320 executes a program corresponding thereto.

The memory 330 is a storage area for storing various programs that the processor 320 executes and data that the processor 320 reads therefrom or writes thereto. The memory 330 stores a setting information management table 331. A correspondence between the wireless AP name and setting information is registered in the setting information management table 331. Details of the setting information management table 331 will be described later using FIG. 5.

The physical port 340 is connected to a line to be connected to the network 50.

FIG. 2 is an explanatory view of the DHCP processing section 221 according to the first embodiment of the present invention.

The DHCP processing section 221 includes a DHCP snooping processing section 2210, a DHCP relay processing section 2220, and a DHCP server processing section 2230.

The DHCP snooping processing section 2210 executes DHCP snooping processing. The DHCP snooping processing is processing of snooping to which physical port of the packet relay device 20 the DHCP client is connected and filtering a packet based on a result of the snooping.

The DHCP relay processing section 2220 executes DHCP relay processing. The DHCP relay processing is processing of receiving the DHCP packet from the DHCP client on behalf of the DHCP server 40 and relaying the DHCP packet, to the DHCP server 40 existing on a different network.

The DHCP server processing section 2230 executes DHCP server processing. The DHCP server processing is processing of implementing a function of the DHCP server 40 in the packet relay device 20 and automatically assigning information, such as an IP address of the DHCP client, required for network utilization to the DHCP client.

An administrator previously set whether to validate or invalidate the function of each of the DHCP snooping processing section 2210, DHCP relay processing section 2220, and DHCP server processing section 2230. The processing section whose function has been validated executes its own processing, and the processing section whose function has been invalidated does not execute its own processing. It is assumed in the present embodiment that the function of the DHCP snooping processing section 2210 is set valid, while the functions of the DHCP relay processing section 2220 and DHCP server processing section 2230 are set invalid. Processing section setting information (not illustrated) indicating whether each of the processing sections is set valid or invalid is stored in the memory 230.

The DHCP snooping processing section 2210 includes a reception port confirmation section 2211, a wireless AP determination section 2212, and a DHCP data adding section 2213.

The reception port confirmation section 2211 identifies a physical port through which the DHCP packet is received. The wireless AP determination section 2212 determines whether or not the wireless AP identification information is stored in Options of the DHCP packet to thereby determine the DHCP client of the DHCP packet is the wireless AP 10.

When it is determined by the wireless AP determination section 2212 that the DHCP client of received DHCP ACK is the wireless AP 10, the DHCP data adding section 2213 acquires the wireless AP name from the wireless AP registration table 232 and the IP address of the management server 30 from the management server IP registration table 231 based on the identification information of the physical port identified by the reception port confirmation section 2211. Then, the DHCP data adding section 2213 adds the acquired wireless AP name and IP address of the management server 30 to the received DHCP ACK.

FIG. 3 is an explanatory view of the wireless AP registration table 232 according to the first embodiment of the present invention.

A correspondence between the identification information of the physical port provided in the packet relay device 20 and wireless AP name based on which the wireless AP 10 connected to the physical port is identified is registered in the wireless AP registration table 232. The wireless AP registration table 232 is previously set by an administrator.

The wireless AP registration table 232 has physical port identification information 301 and a wireless AP name 302.

The identification information (e.g., a port number) of the physical port provided in the packet relay device 20 is registered in the physical port identification information 301. The wireless AP name of the wireless AP 10 connected to the physical port identified by the identification information registered in the physical port identification information 301 is registered in the wireless AP name 302. The wireless AP name is information that can identify the wireless AP 10 and is not changed when the wireless AP 10 is replaced with a new one. For example, the wireless AP name is information indicating a position at which the wireless AP 10 is installed.

A correspondence between a physical port “1” and a wireless AP name “A,” a correspondence between a physical port “2” and a wireless AP name “B,” and a correspondence between a physical port “3” and a wireless AP name “C” are registered in the wireless AP registration table 232 illustrated in FIG. 3.

Records corresponding to the number of the physical ports to be connected to the wireless AP 10 may be registered in the wireless AP registration table 232; alternatively, a configuration may be adopted, in which records corresponding to the number of all the ports provided in the packet relay device 20 are registered in the wireless AP registration table 232, and “NULL” is registered as the wireless AP name 302 of the physical port that is not connected to the wireless AP 10. The identification information of the physical port to be registered in the physical port identification information 301 may be any information as long as it can uniquely identify one of the physical ports provided in the packet relay device 20. Further, the wireless AP name to be registered in the wireless AP name 302 may be any information as long as it can identify a new wireless AP 10 installed for replacement.

FIG. 4 is an explanatory view of the management server IP registration table 231 according to the first embodiment of the present invention.

The IP address of the management server 30 that stores the setting information of the wireless AP 10 is registered in the management server IP registration table 231. The management server IP registration table 231 has a management server IP address 401, and the IP address of the management server 30 is registered in the management server IP address 401. Address information, such as a MAC address, of the management server 30 may be registered in the management server IP registration table 231 as long as it can identify the management server 30.

The management server IP registration table 231 is previously set by an administrator. When the management server 30 that stores the setting information differs for each the wireless AP 10, IP addresses of a plurality of management servers 30 are registered in the management server IP registration table 231. In this case, the management server IP registration table 231 includes a wireless AP name (not illustrated) and a management server IP address 401, and in the management server IP registration table 231, a correspondence between the wireless AP 10 identified by the wireless AP name and IP address of the management server 30 that stores the setting information of the wireless AP 10 is registered.

FIG. 5 is an explanatory view of the setting information management table 331 according to the first embodiment of the present invention.

In the setting information management table 331, a correspondence between the wireless AP name and setting information that the management server 30 transmits to the wireless AP 10 identified by the wireless AP name.

The setting information management table 331 includes a packet relay device identification information 501, a physical port identification information 502, a wireless AP name 503, and setting information 504.

Identification information of the packet relay device 20 to be connected to the management server 30 is registered in the packet relay device identification information 501. Identification information of the physical port of each packet relay device 20 to which the wireless AP 10 is connected is registered in the physical port identification information 502. The wireless AP name of the wireless AP 10 to be connected to each physical port is registered in the wireless AP name 503. Setting information corresponding to the wireless AP 10 identified by the wireless AP name 503 is registered in the setting information 504. The setting information includes at least one of, e.g., a radio field intensity of the wireless AP 10, a channel for the wireless AP 10 to exchange data by wireless with the wireless terminal 1, and an encryption/authentication method.

That is, the setting information management table 331 manages which wireless AP 10 is connected to which physical port of the packet relay device 20 and manages a correspondence between the wireless AP 10 and setting information of the wireless AP 10.

There are registered, in the setting information management table 331 illustrated in FIG. 5, a correspondence among a physical port “1” of a packet relay device “SW1,” a wireless AP name “A,” and setting information “a,” a correspondence among a physical port “2” of the packet relay device “SW1,” a wireless AP name “B,” and setting information “b,” a correspondence among a physical port “3” of the packet relay device “SW1”, a wireless AP name “C,” and setting information “c,” a correspondence among a physical port “1” of a packet relay device “SW2,” a wireless AP name “L,” and setting information “1,” and a correspondence among a physical port “3” of the packet relay device “SW2,” a wireless AP name “M,” and setting information “m.”

The setting information management table 331 is previously set by an administrator. Further, the correspondence between the identification information of the physical port of the packet relay device 20 and the wireless AP name may be automatically registered in the wireless AP registration table 232 of each packet relay device 20. Specifically, the management server 30 transmits, to the packet relay device 20 identified by the identification information registered in the packet relay device identification information 501, a correspondence between the identification information of the physical port registered in the physical port identification information 502 of the setting information management table 331 and the wireless AP name registered in the wireless AP name 503 of the setting information management table 331. When receiving the correspondence transmitted from the management server 30, the packet relay device 20 registers the received correspondence in the wireless AP registration table 232.

The identification information of the packet relay device 20 to be registered in the packet relay device identification information 501 may be any information as long as it can uniquely identify the packet relay device 20. Further, the identification information of the physical port to be registered in the physical port identification information 502 may be any information as long as it can uniquely identify the physical port provided in the packet relay device 20. Further, the wireless AP name to be registered in the wireless AP name 503 may be any information as long as it can identify a new wireless AP 10 installed for replacement. The setting information to be registered in the setting information 504 may be arbitrary setting information.

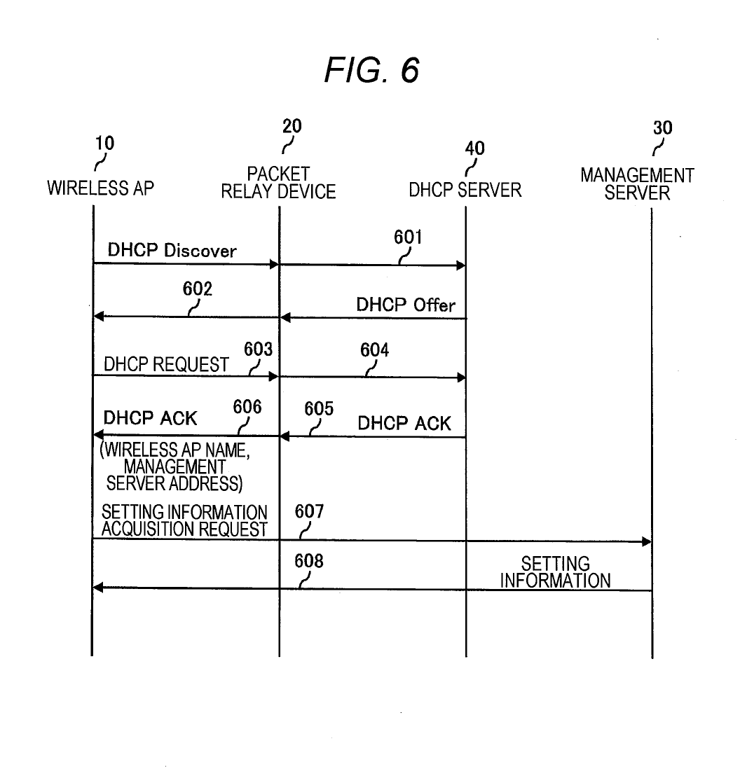

FIG. 6 is a sequence diagram of processing to be performed in the network system when the wireless AP 10 according to the first embodiment of the present invention is replaced with a new one.

When the new wireless AP 10 is connected to the packet relay device 20, the DHCP client processing section 140 of the wireless AP 10 transmits, in a broadcast manner, DHCP Discover so as to acquire an IP address from the DHCP server 40 (601). This allows the DHCP client processing section 140 to transmit the DHCP Discover over the network in the same segment. The DHCP Discover transmitted from the wireless AP 10 is transmitted to the network 50 through the packet relay device 20.

When receiving the DHCP Discover transmitted in step 601, the DHCP server 40 transmits, to the DHCP client, DHCP Offer including an IP address that the DHCP client (wireless AP 10) can use (602). The DHCP client is a device to which the DHCP Discover is transmitted and refers to, in the present embodiment, the new wireless AP 10.

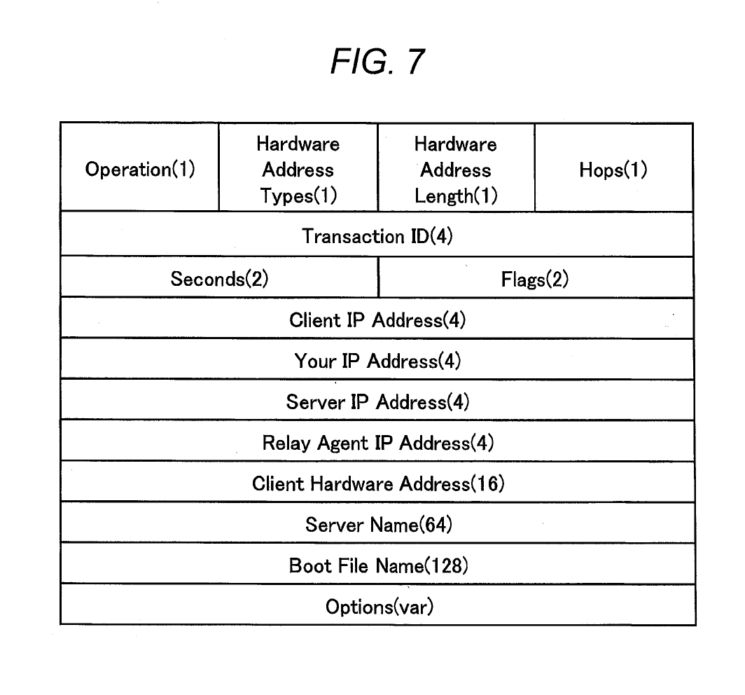

When the IP address included in the DHCP Offer received by the wireless AP 10 as the DHCP client is appropriate, the wireless AP information adding section 141 adds the wireless AP identification information to a DHCP request (address acquisition request) which is a request for acquiring the IP address set in the wireless AP 10, and the DHCP client processing section 140 transmits the DHCP request including the wireless AP identification information (603). Although details will be described using FIG. 7, the wireless AP identification information is stored in Options of the DHCP request.

When the DHCP request transmitted in step 603 is received by the packet relay device 20, the DHCP processing section 221 of the packet relay device 20 identifies the physical port through which the DHCP request is received and stores the identification information of the identified physical port and then transmits the DHCP request to the network 50 (604).

When receiving the DHCP request transmitted in step 604, the DHCP server 40 transmits DHCP ACK (address acquisition reply) corresponding to the received DHCP request (605). The DHCP ACK includes the IP address of the DHCP client.

When the DHCP ACK transmitted in step 605 is received by the packet relay device 20, the DHCP processing section 221 of the packet relay device 20 adds, to the received DHCP ACK, the wireless AP name corresponding to the identification information of the physical port through which the DHCP request corresponding to the received DHCP ACK is received and IP address of the management server 30 and transmits the DHCP ACK including the wireless AP name and IP address of the management server 30 to the wireless AP 10 (606). The wireless AP name corresponding to the identification information of the physical port through which the DHCP request corresponding to the received DHCP ACK is received is identified by the wireless AP management section 222 referring to the wireless AP registration table 232, and the IP address of the management server 30 is identified by the management server IP processing section 223 referring to the management server IP registration table 231. Although details will be described using FIG. 7, the wireless AP name and IP address of the management server 30 are stored in Options of the DHCP ACK.

When the DHCP ACK transmitted in step 606 is received by the wireless AP 10, the device IP address management section 130 of the wireless AP 10 stores the IP address of the wireless AP 10 included in the received DHCP ACK, and the management server information processing section 150 registers the IP address of the management server 30 included in the received DHCP ACK in the management server IP registration table 151.

Then, the management server inquiry section 152 of the wireless AP 10 transmits the setting information acquisition request including the stored wireless AP name with the IP address of the management server 30 registered in the management server IP registration table 151 set as a destination (607).

When the setting information acquisition request transmitted in step 607 is received by the management server 30, the setting information management section 322 of the management server 30 refers to the setting information management table 331 and identifies setting information corresponding to the wireless AP name included in the received setting information acquisition request, and the setting information transmission section 323 transmits the identified setting information to the wireless AP 10 (608).

Specifically, the setting information management section 322 refers to the setting information management table 331 and identifies setting information registered in the setting information 504 in the record in which the wireless AP name included in the received setting information acquisition request is registered in the wireless AP name 503. Alternatively, the setting information management section 322 may identify, by referring to the refers to the setting information management table 331, setting information registered in the setting information 504 in the record in which the identification information of the packet relay device 20 as a transmission source of the setting information acquisition request is registered in the packet relay device identification information 501 and in which the wireless AP name included in the received setting information acquisition request is registered in the wireless AP name 503.

When the setting information transmitted in step 608 is received by the wireless AP 10, the configuration information setting section 160 of the wireless AP 10 executes various settings based on the received setting information.

FIG. 7 is a format diagram of the DHCP packet according to the first embodiment of the present invention.

The DHCP packet includes the DHCP Discover, DHCP Offer, DHCP request, and DHCP ACK to be exchanged between the wireless AP 10 and DHCP server 40.

The format of the DHCP packet is defined as illustrated in FIG. 7. Information unique to the present embodiment is stored in an undefined area of Options of the DHCP packet, and the resultant DHCP packet is transmitted. The information unique to the present embodiment includes, e.g., the wireless AP identification information to be added to the DHCP request to be transmitted in step 603, wireless AP name and IP address of the management server 30 to be added to the DHCP ACK to be transmitted in step 606, and the like.

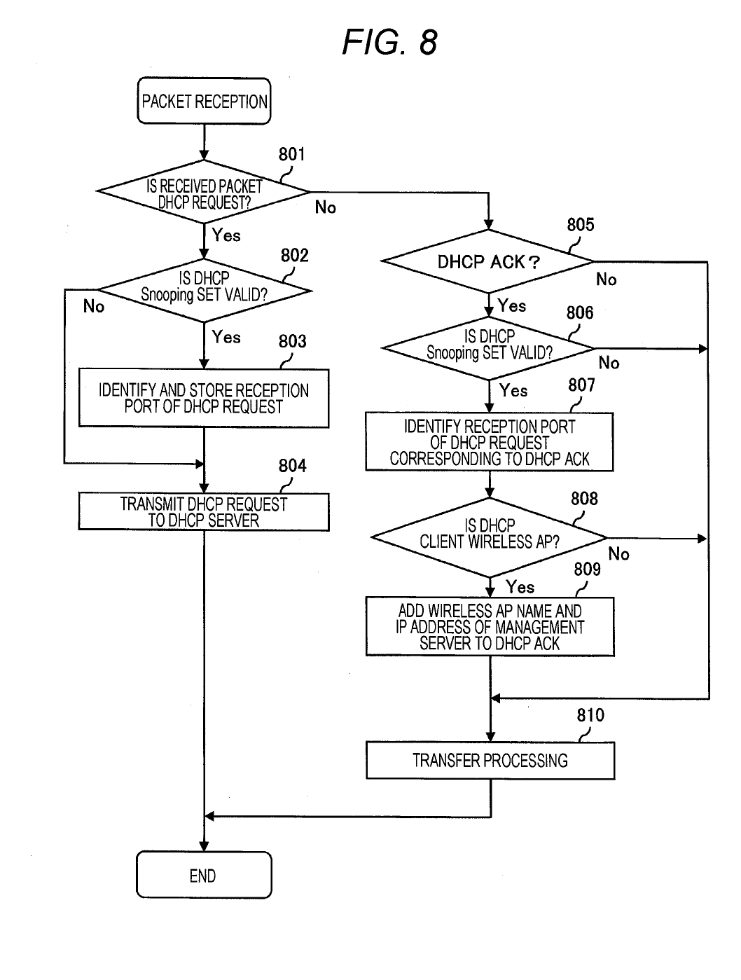

FIG. 8 is a flowchart of packet transfer processing to be executed by the packet relay device 20 according to the first embodiment of the present invention.

The packet transfer processing is executed when the packet relay device 20 receives a packet.

When the packet relay device 20 receives a packet, the DHCP packet determination section 211 determines whether or not the received packet is a DHCP request (801).

When it is determined in step 801 that the received packet is the DHCP request, the DHCP processing section 221 refers to not illustrated processing section setting information stored in the memory 230 and determines whether or not the DHCP Snooping processing section 2210 is set valid (802).

When it is determined in step 802 that the DHCP Snooping processing section 2210 is set valid, the reception port confirmation section 2211 of the DHCP Snooping processing section 2210 identifies, based on the received DHCP request, the physical port through which the DHCP request is received and associates the identification information of the identified physical port and Transaction ID of the DHCP request with each other for storage in the memory 230 (803).

The packet processing section 210 transmits the received DHCP request to the network 50 (804), and this routine is ended.

On the other hand, when it is determined in step 802 that the DHCP Snooping processing section 2210 is set invalid, the flow proceeds to step 804, where the packet processing section 210 transmits the received request to the network 50, and this routine is ended.

When it is determined in step 801 that the received packet is not the DHCP request, the DHCP packet determination section 211 determines whether or not the received packet is the DHCP ACK (805).

When it is determined in step 805 that the received packet is the DHCP ACK, the DHCP processing section 221 refers to the not illustrated processing section setting information stored in the memory 230 and determines whether or not the DHCP Snooping processing section 2210 is set valid (806).

When it is determined in step 806 that the DHCP Snooping processing section 2210 is set valid, the reception port confirmation section 2211 of the DHCP Snooping processing section 2210 acquires the Transaction ID of the DHCP ACK and identifies the identification information of the physical port associated with the acquired Transaction ID (807). The identification information of the physical port identified in step 807 is the identification information of the physical port through which the DHCP request corresponding to the received DHCP ACK is received.

Then, the wireless AP determination section 2212 of the DHCP processing section 221 determines whether or not the DHCP client of the received DHCP ACK is the wireless AP 10 (808). Specifically, the wireless AP determination section 2212 determines that the DHCP client of the received DHCP ACK is the wireless AP 10 when the wireless AP identification information is stored in the Options of the received DHCP ACK.

When it is determined in step 808 that the DHCP client of the received DHCP ACK is the wireless AP 10, the DHCP data adding section 2213 of the DHCP Snooping processing section 2210 adds, to the Options of the DHCP ACK, the wireless AP name corresponding to the physical port identified in step 807 and IP address of the management server 30 (809).

Specifically, the wireless AP management section 222 acquires, from the records of the wireless AP registration table 232, the wireless AP name registered in the wireless AP name 302 in the record in which the identification information of the physical port that the reception port confirmation section 2211 identifies in step 807 is registered in the physical port identification information 301. Further, the management server IP processing section 223 refers to the management server IP registration table 231 and acquires the IP address of the management server 30. Then, the DHCP data adding section 2213 adds, to the DHCP ACK, the wireless AP name acquired by the wireless AP management section 222 and IP address of the management server 30 acquired by the management server IP processing section 223.

Then, the packet processing section 210 transmits, to the wireless AP 10, the DHCP ACK to which the wireless AP name and IP address of the management server 30 are added in step 809 (810), and this routine is ended.

When it is determined in step 806 that the DHCP Snooping processing section 2210 is set invalid, and when it is determined in step 808 that the DHCP client of the received DHCP ACK is not the wireless AP 10, the flow proceeds to step 810, where the packet processing section 210 transmits the DHCP ACK to the DHCP client, and this routine is ended.

When it is determined in step 805 that the received packet is not the DHCP ACK, the packet processing section 210 transmits the received packet in step 810, and this routine is ended.

As described above, according to the present embodiment, when the wireless AP 10 is replaced with a new wireless AP 10, the packet relay device 20 transmits, to the new wireless AP 10, the DHCP ACK corresponding to the DHCP request transmitted from the new wireless AP 10, including therein the wireless AP name of the new wireless AP 10 and IP address of the management server 30. Thus, even when the wireless AP 10 is replaced with a new wireless AP 10, it is possible to acquire the setting information of the new wireless AP 10 from the management server 30 only by connecting the new wireless AP 10 to the packet relay device 20, thereby allowing initial setting of the new wireless AP 10 to be automatically performed without manual intervention.

Further, it is not necessary to make special settings for the DHCP server 40, allowing the network system of the present embodiment to be easily incorporated in the existing network.

### Second Embodiment

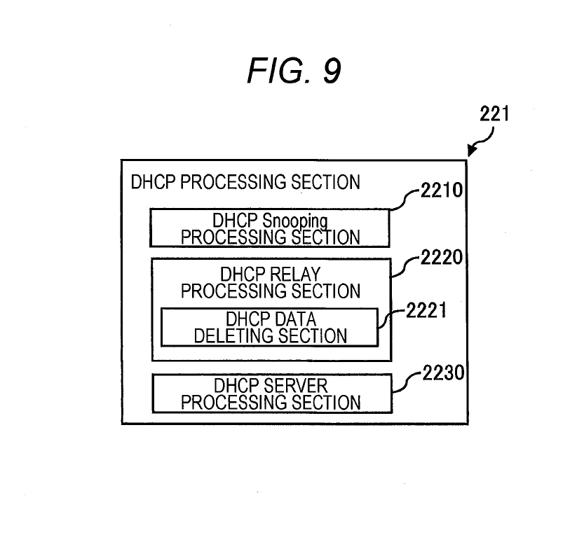

A second embodiment of the present invention will be described with reference to FIGS. 9 to 13.

In the first embodiment, the packet relay device 20 adds the wireless AP name and IP address of the management server 30 to the DHCP ACK; while in the second embodiment, the DHCP server 40 adds the wireless AP name and IP address of the management server 30 to the DHCP ACK.

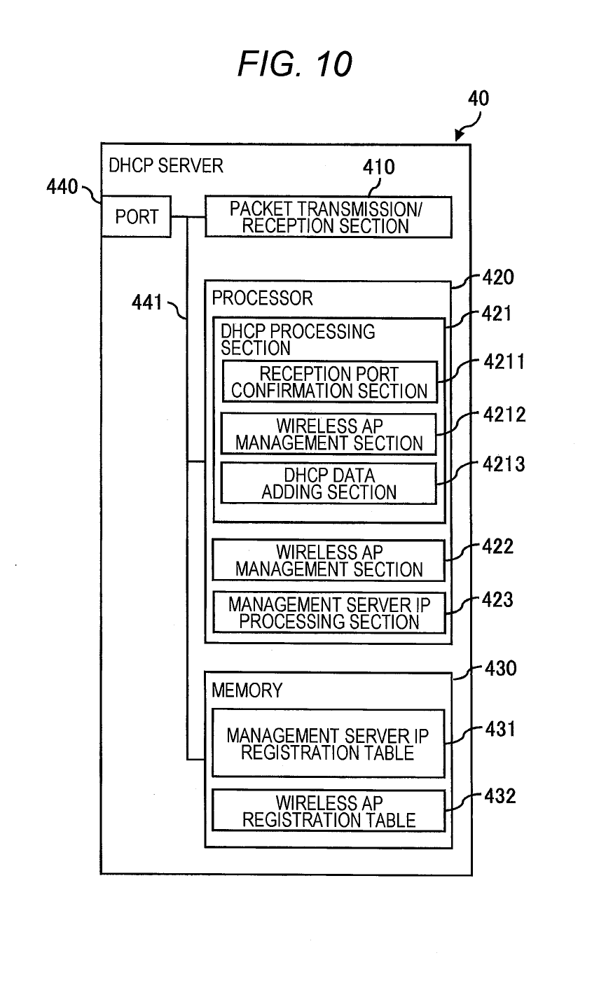

The management server IP registration table 231 and wireless AP registration table 232, which are stored in the memory 230 of the packet relay device 20 in the network system of the first embodiment, are stored in a memory 430 (see FIG. 10) of the DHCP server 40 in a network system of the second embodiment. Thus, the packet relay device 20 of the present embodiment does not include the wireless AP management section 222 and management server IP processing section 223. Further, the DHCP processing section 221 of the packet relay device 20 and DHCP server 40 differ from those of the first embodiment, so the DHCP processing section 221 of the packet relay device 20 and DHCP server 40 of the present embodiment will be described with reference to FIG. 9 and FIG. 10, respectively. The wireless AP 10 and management server 30 of the present embodiment are the same as those of the first embodiment, so descriptions thereof will be omitted.

FIG. 9 is an explanatory view of a DHCP processing section 221 provided in the packet relay device 20 according to the second embodiment of the present invention.

The DHCP processing section 221 includes a DHCP Snooping processing section 2210, a DHCP relay processing section 2220, and a DHCP server processing section 2230.

The DHCP Snooping processing section 2210 differs from the DHCP Snooping processing section 2210 of the first embodiment and does not include the reception port confirmation section 2211, wireless AP determination section 2212, and DHCP data adding section 2213.

The DHCP relay processing section 2220 includes a DHCP data deleting section 2221. The DHCP data deleting section 2221 deletes, before transmission of the DHCP Offer and DHCP ACK, Option 82 information that the packet relay device 20 embeds in the DHCP Discover and DHCP request. The Option 82 information is information for the packet relay device 20 to notify the DHCP server 40 of the physical port through which the DHCP Discover and DHCP request from the DHCP client is received.

The DHCP server processing section 2230 is the same as that of the first embodiment, so descriptions thereof will be omitted.

In the second embodiment, a function of the DHCP Snooping processing section 2210 for identifying the physical port through which the DHCP packet from the DHCP client is received and a function of the DHCP relay processing section 2220 are set valid.

FIG. 10 is an explanatory view of the DHCP server 40 according to the second embodiment.

The DHCP server 40 includes a packet transmission/reception section 410, a processor 420, a memory 430, and a physical port 440. The packet transmission/reception section 410, processor 420, memory 430, and physical port 440 are connected to each other through a bus 441.

The packet transmission/reception section 410 executes packet transmission/reception processing performed by the DHCP server 40.

The processor 420 executes various programs and includes a DHCP processing section 421, a wireless AP management section 422, and a management server IP processing section 423.

The DHCP processing section 421 executes processing of distributing an IP address to the DHCP client. The DHCP processing section 421 includes a reception port confirmation section 4211, a wireless AP determination section 4212, and a DHCP data adding section 4213.

The reception port confirmation section 4211 identifies the physical port through which the packet relay device 20 receives the DHCP packet from the DHCP client in the same manner as the reception port confirmation section 2211 of the first embodiment. The wireless AP determination section 4212 refers to the DHCP packet and determines whether or not the DHCP client of the DHCP packet is the wireless AP 10 in the same manner as the wireless AP determination section 2212 of the first embodiment. The DHCP data adding section 4213 adds the wireless AP name and IP address of the management server 30 to the DHCP ACK in the same manner as the DHCP data adding section 2213 of the first embodiment.

The wireless AP management section 422 and management server IP processing section 423 are the same as the wireless AP management section 222 of the first embodiment and management server IP processing section 223 of the first embodiment, respectively, so descriptions thereof will be omitted.

The memory 430 is a storage area for storing various programs that the processor 420 executes and data that the processor 420 reads therefrom or writes thereto. The memory 430 stores a management server IP registration table 431 and a wireless AP registration table 432. The management server IP registration table 431 and wireless AP registration table 432 are same as the management server IP registration table 231 of the first embodiment and wireless AP registration table 232 of the first embodiment, respectively, so descriptions thereof will be omitted.

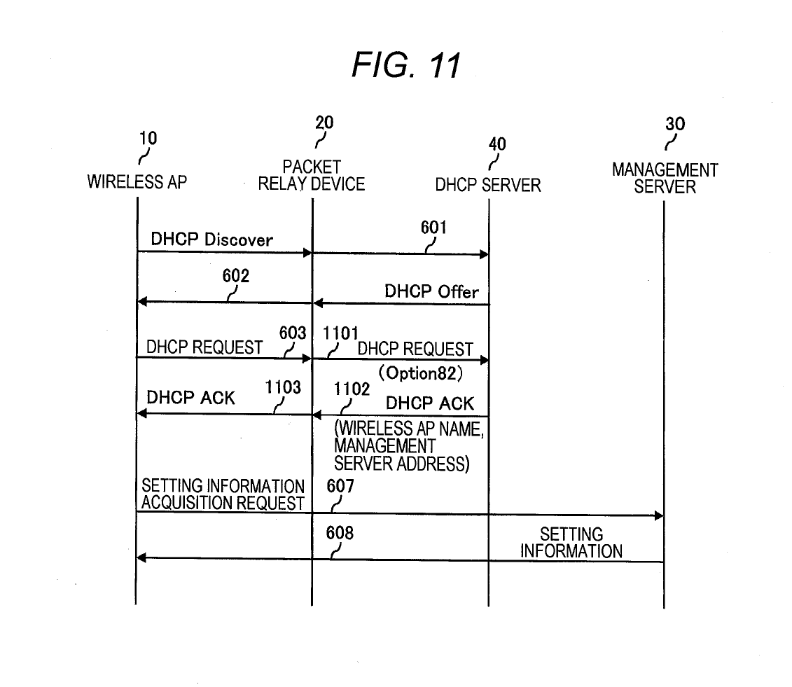

FIG. 11 is a sequence diagram of processing to be performed in the network system when the wireless AP 10 according to the second embodiment of the present invention is replaced with a new one. In FIG. 11, the same reference numerals are given to the same processing as those in FIG. 6 of the first embodiment, and descriptions thereof will be omitted.

When receiving the DHCP request transmitted from the wireless AP 10 in step 603, the packet relay device 20 uses a function of Option 82 of the DHCP relay processing section 2220 to add, to the DHCP request, the Option 82 information including an MAC address thereof and identification information of the physical port through which the DHCP request is received and transmits the resultant DHCP request to the network 50 (1101).

When the DHCP request is received by the DHCP server 40, the DHCP processing section 421 of the DHCP server 40 refers to the Option 82 included in the received DHCP request and identifies the physical port through which the packet relay device 20 receives the DHCP request. Then, the wireless AP management section 422 refers to the wireless AP registration table 432 and acquires the wireless AP name corresponding to the identification information of the identified physical port, and the management server IP processing section 423 refers to the management server IP registration table 431 and acquires the IP address of the management server 30. Then, the DHCP processing section 421 transmits the DHCP ACK including the acquired wireless AP name and acquired IP address of the management server 30 (1102).

When the DHCP ACK transmitted in step 1102 is received by the packet relay device 20, the DHCP data deleting section 2221 provided in the DHCP relay processing section 2220 of the DHCP processing section 221 deletes the Option 82 information of the received DHCP ACK and transmits the resultant DHCP ACK to the wireless AP 10 (1103).

In the manner as described above, the DHCP server 40 adds the wireless AP name and IP address of the management server 30 to the DHCP ACK and transmits the resultant DHCP ACK. The packet relay device 20 only needs to validate the function of the Option 82, and it is not necessary to make special settings for the packet relay device 20. This allows the network system of the present embodiment to be easily incorporated in the existing network.

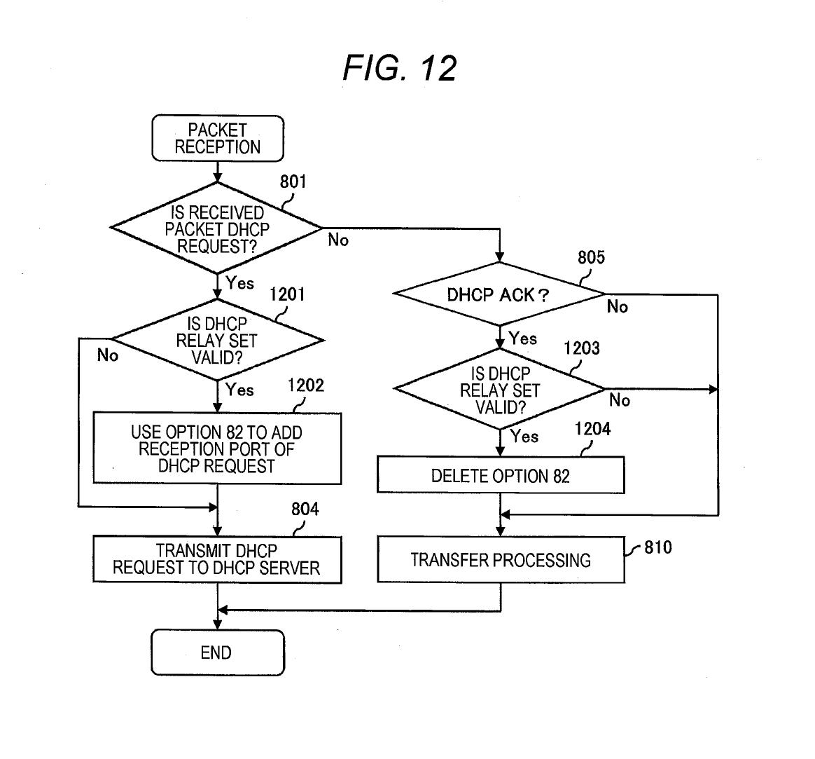

FIG. 12 is a flowchart of packet transfer processing to be executed by the packet relay device 20 according to the second embodiment of the present invention. In FIG. 12, the same reference numerals are given to the same processing as those in FIG. 8 of the first embodiment, and descriptions thereof will be omitted.

When it is determined in step 801 that the received packet is the DHCP request, the DHCP processing section 221 refers to not illustrated processing section setting information stored in the memory 230 and determines whether or not the DHCP relay processing section 2220 is set valid (1201).

When it is determined in step 1201 that the DHCP relay processing section 2220 is set valid, the DHCP relay processing section 2220 uses the function of the Option 82 to add, to the received DHCP request, the Option 82 information including the identification information of the physical port (physical port connected to the DHCP client) through which the packet relay device 20 receives the DHCP request and MAC address of the packet relay device 20 (1202), and the flow proceeds to step 804. In step 804, the packet processing section 210 transmits the DHCP request including the Option 82 information to the network 50.

On the other hand, when it is determined in step 1201 that the DHCP relay processing section 2220 is set invalid, the flow proceeds to step 804, where the packet processing section 210 transmits the received request to the network 50.

When it is determined in step 805 that the received packet is the DHCP ACK, the DHCP processing section 221 refers to the not illustrated processing section setting information stored in the memory 230 and determines whether or not the DHCP relay processing section 2220 is set valid (1203).

When it is determined in step 1203 that the DHCP relay processing section 2220 is set valid, the DHCP data deleting section 2221 of the DHCP relay processing section 2220 deletes the Option 82 information of the received DHCP ACK (1204), and the flow proceeds to step 810. In step 810, the packet processing section 210 transmits the received DHCP ACK to the wireless AP 10.

On the other hand, when it is determined in step 1203 that the DHCP relay processing section 2220 is set invalid, the flow proceeds to step 810, where the packet processing section 210 transmits the received DHCP ACK to the wireless AP 10.

Thus, when receiving the DHCP request, the packet relay device 20 can notify the DHCP server 40 of the identification information of the physical port through which the DHCP request is received and can delete the Option 82 information of the DHCP ACK received from the DHCP server 40.

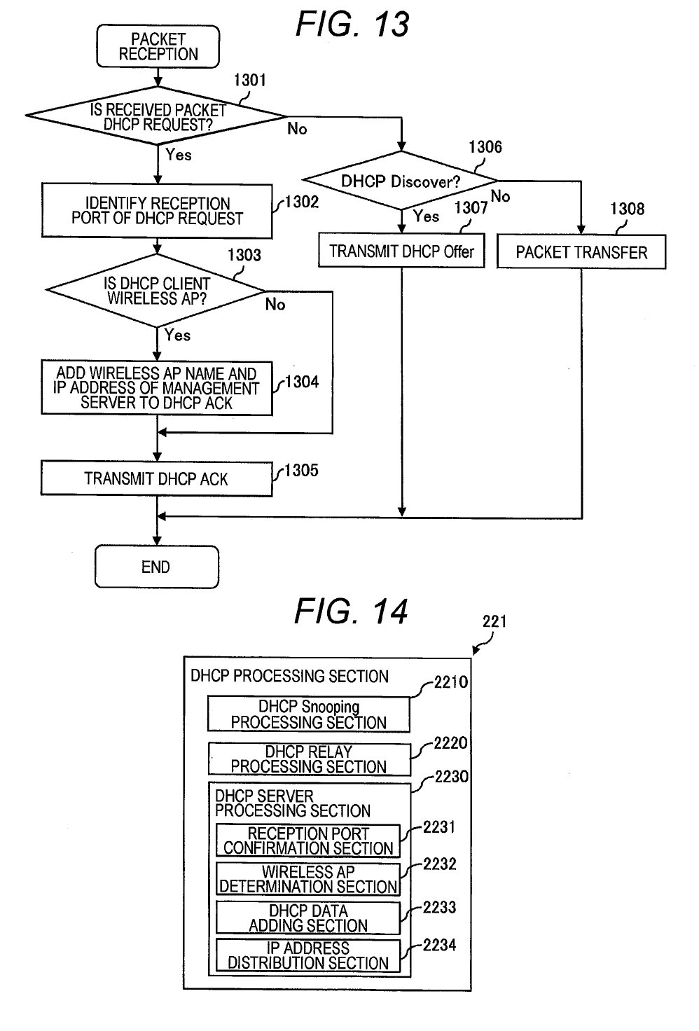

FIG. 13 is a flowchart of packet transfer processing to be executed by the DHCP server 40 according to the second embodiment of the present invention.

The packet transfer processing is executed when the DHCP server 40 receives a packet.

When the DHCP server 40 receives a packet, the packet transmission/reception section 410 determines whether or not the received packet is the DHCP request (1301).

When it is determined in step 1301 that the received packet is the DHCP request, the reception port confirmation section 4211 of the DHCP processing section 421 identifies the physical port of the packet relay device 20 through which the DHCP request is received based on the Option 82 information of the received DHCP request (1302).

Then, the wireless AP determination section 4212 of the DHCP processing section 421 determines whether or not the DHCP client of the received DHCP request is the wireless AP 10 (1303). A determination method of step 1303 is the same as that of step 808 of FIG. 8, so descriptions thereof will be omitted.

When it is determined in step 1303 that the DHCP client of received DHCP request is the wireless AP 10, the DHCP data adding section 4213 of the DHCP processing section 421 adds, to the Options of the DHCP ACK, the acquired wireless AP name corresponding to the physical port identified in step 1302 and IP address of the management server 30 (1304).

Specifically, the wireless AP management section 422 acquires, from the records of the wireless AP registration table 432, the wireless AP name registered in the wireless AP name 302 in the record in which the identification information of the physical port that the reception port confirmation section 4211 identifies in step 1302 is registered in the physical port identification information 301. Further, the management server IP processing section 423 refers to the management server IP registration table 431 and acquires the IP address of the management server 30. Then, the DHCP data adding section 4213 adds, to the DHCP ACK, the wireless AP name acquired by the wireless AP management section 422 and IP address of the management server 30 acquired by the management server IP processing section 423.

Then, the packet transmission/reception section 410 transmits the DHCP ACK to the network 50 (1305), and this routine is ended.

On the other hand, when it is determined in step 1303 that the DHCP client of the received DHCP request is not the wireless AP 10, the flow proceeds to step 1305, where the packet transmission/reception section 410 transmits the DHCP ACK, and this routine is ended.

When it is determined in step 1301 that the received packet is not the DHCP request, the packet transmission/reception section 410 determines whether or not the received packet is the DHCP Discover (1306).

When it is determined in step 1306 that the received packet is the DHCP Discover, the DHCP processing section 421 identifies the IP address that the DHCP client that has transmitted the DHCP Discover can use, and the packet transmission/reception section 410 transmits the DHCP Offer including the identified IP address (1307), and this routine is ended.

On the other hand, when it is determined in step 1306 that the received packet is not the DHCP Discover, which means that the received packet is the DHCP packet but a normal packet, so the packet transmission/reception section 410 transfers the received packet (1308), and this routine is ended.

As described above, according to the present embodiment, when the wireless AP 10 is replaced with a new wireless AP 10, the DHCP server 40 transmits, to the new wireless AP 10, the DHCP ACK corresponding to the DHCP request transmitted from the new wireless AP 10, including therein the wireless AP name of the new wireless AP 10 and IP address of the management server 30. Thus, even when the wireless AP 10 is replaced with a new wireless AP 10, it is possible to acquire the setting information of the new wireless AP 10 from the management server 30 only by connecting the new wireless AP 10 to the packet relay device 20, thereby allowing initial setting of the new wireless AP 10 to be automatically performed without manual intervention.

Further, it is not necessary to make special settings for the packet relay device 20, allowing the network system of the present embodiment to be easily incorporated in the existing network.

### Third Embodiment

A third embodiment of the present invention will be described with reference to FIGS. 14 to 16.

In the present embodiment, the function of the DHCP server 40 is implemented in the packet relay device 20, and the packet relay device 20 adds the wireless AP name and IP address of the management server 30 to the DHCP ACK and transmits the resultant DHCP ACK to the wireless AP 10.

Since the function of the DHCP server 40 is implemented in the packet relay device 20, a network system of the present embodiment need not be provided with the DHCP server 40. Accordingly, in the present embodiment, the DHCP processing section 221 of the packet relay device 20 differs from that of the first embodiment. Hereinafter, a configuration of the DHCP processing section 221 according to the present embodiment will be described with reference to FIG. 14.

FIG. 14 is an explanatory view of the DHCP processing section 221 according to the third embodiment of the present invention.

The DHCP processing section 221 includes a DHCP Snooping processing section 2210, a DHCP relay processing section 2220, and a DHCP server processing section 2230.

The DHCP Snooping processing section 2210 differs from the DHCP Snooping processing section 2210 of the first embodiment and does not include the reception port confirmation section 2211, wireless AP determination section 2212, and DHCP data adding section 2213.

The DHCP relay processing section 2220 is the same as the DHCP relay processing section 2220 of the first embodiment, so descriptions thereof will be omitted.

The DHCP server processing section 2230 differs from that of the first embodiment and includes a reception port confirmation section 2231, a wireless AP determination section 2232, a DHCP data adding section 2233, and an IP address distribution section 2234.

The reception port confirmation section 2231 identifies the physical port through which the packet relay device 20 receives the DHCP packet from the DHCP client in the same manner as the reception port confirmation section 2211 of the first embodiment. The wireless AP determination section 2232 refers to the DHCP packet and determines whether or not the DHCP client of the DHCP packet is the wireless AP 10 in the same manner as the wireless AP determination section 2212 of the first embodiment. The DHCP data adding section 2233 adds the wireless AP name and IP address of the management server 30 to the DHCP ACK in the same manner as the DHCP data adding section 2213 of the first embodiment.

The IP address distribution section 2234 manages and determines the IP address to be distributed to the DHCP client.

In the present embodiment, the function of the DHCP server processing section 2230 is set valid.

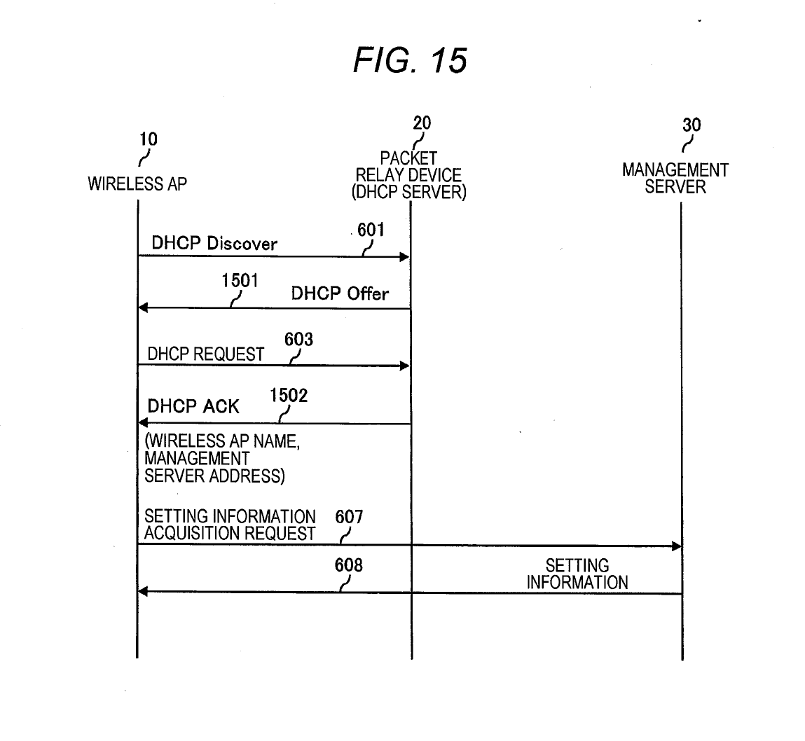

FIG. 15 is a sequence diagram of processing to be performed in the network system when the wireless AP 10 according to the third embodiment of the present invention is replaced with a new one. In FIG. 15, the same reference numerals are given to the same processing as those in FIG. 6 of the first embodiment, and descriptions thereof will be omitted.

When the DHCP Discover transmitted from the wireless AP 10 is received by the packet relay device 20 in step 601, the DHCP server processing section 2230 provided in the DHCP processing section 221 of the packet relay device 20 transmits the DHCP Offer to the wireless AP 10 (1501).

When the DHCP request transmitted from the wireless AP 10 is received by the packet relay device 20 in step 603, the DHCP server processing section 2230 of the packet relay device 20 identifies the physical port through which the DHCP request is received and determines the IP address to be distributed to the DHCP client. Further, since the DHCP client of the received DHCP request is the wireless AP 10, the DHCP server processing section 2230 transmits the DHCP ACK including the wireless AP name corresponding to the identification information of the identified physical port, IP address of the management server 30, and IP address to be distributed (1502).

Thus, even when the wireless AP 10 is replaced with a new wireless AP 10 in the configuration in which the function of the DHCP server 40 is implemented in the packet relay device 20, it is possible to acquire the setting information of the new wireless AP 10 from the management server 30 only by connecting the new wireless AP 10 to the packet relay device 20.

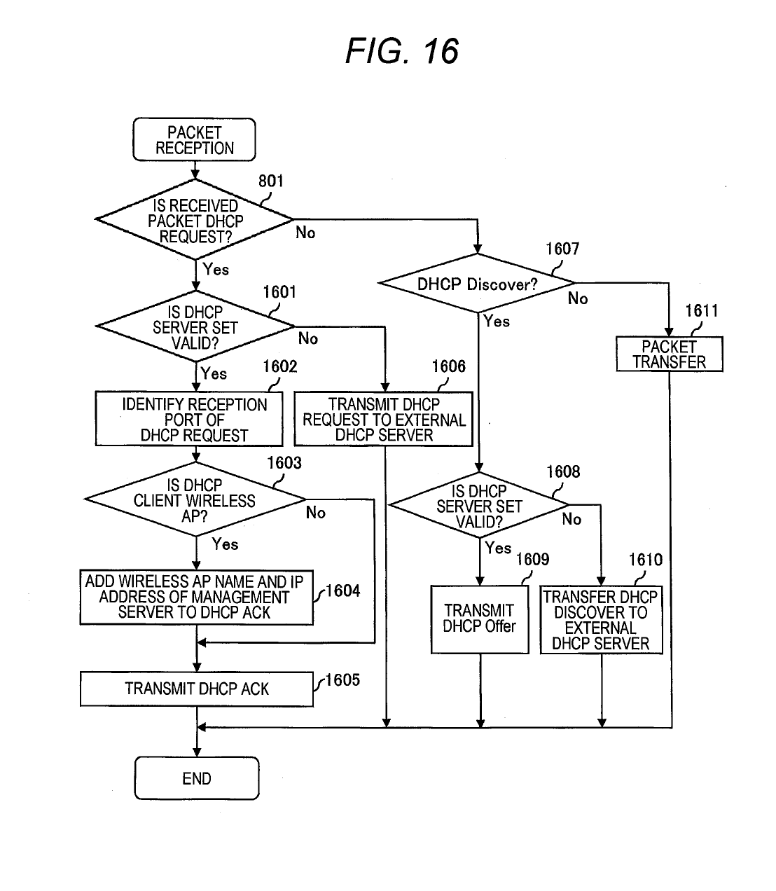

FIG. 16 is a flowchart of packet transfer processing to be executed by the packet relay device 20 according to the third embodiment of the present invention. In FIG. 16, the same reference numerals are given to the same processing as those in FIG. 8 of the first embodiment, and descriptions thereof will be omitted.

When it is determined in step 801 that the received packet is the DHCP request, the DHCP processing section 221 refers to the not illustrated processing section setting information stored in the memory 230 and determines whether or not the DHCP server processing section 2230 is set valid (1601).

When it is determined in step 1601 that the DHCP server processing section 2230 is set valid, the reception port confirmation section 2231 of the DHCP server processing section 2230 identifies, based on the received DHCP request, the physical port through which the DHCP request is received (1602).

Then, the wireless AP determination section 2232 of the DHCP server processing section 2230 determines whether or not the DHCP client of the received DHCP request is the wireless AP 10 (1603).

When it is determined in step 1603 that the DHCP client of the received DHCP request is the wireless AP 10, the DHCP data adding section 2233 of the DHCP server processing section 2230 adds, to the DHCP ACK, the wireless AP name corresponding to the physical port identified in step 1602 and IP address of the management server 30 (1604). The processing in step 1604 is the same as that in step 809 of FIG. 8, so descriptions thereof will be omitted.

Then, the IP address distribution section 2234 determines the IP address to be distributed to the wireless AP 10 which is the DHCP client, the DHCP data adding section 2233 adds the IP address determined by the IP address distribution section 2234 to the DHCP ACK, and the packet processing section 210 transmits the resultant DHCP ACK to the wireless AP 10 (1605), and this routine is ended.

On the other hand, when it is determined in step 1603 that the DHCP client of the received DHCP request is not the wireless AP 10, the flow proceeds to step 1605, where the IP address distribution section 2234 determines the IP address to be distributed to the DHCP client, the DHCP data adding section 2233 adds the IP address determined by the IP address distribution section 2234 to the DHCP ACK, and the packet processing section 210 transmits the resultant DHCP ACK to the DHCP client, and this routine is ended.

When it is determined in step 1601 that the DHCP server processing section 2230 is set invalid, the packet processing section 210 transmits the received DHCP request to an external DHCP server 40 (1606), and this routine is ended.

When it is determined in step 801 that the received packet is not the DHCP request, the DHCP packet determination section 211 determines whether or not the received packet is the DHCP Discover (1607).

When it is determined in step 1607 that the received packet is the DHCP Discover, the DHCP processing section 221 refers to the not illustrated processing section setting information stored in the memory 230 and determines whether or not the DHCP server processing section 2230 is set valid (1608).

When it is determined in step 1608 that the DHCP server processing section 2230 is set valid, the DHCP processing section 221 identifies the IP address that the DHCP client that has transmitted the DHCP Discover can use, and the packet processing section 210 transmits the DHCP Offer including the identified IP address (1609), and this routine is ended.

On the other hand, when it is determined in step 1608 that the DHCP server processing section 2230 is set invalid, the packet processing section 210 transmits the received DHCP Discover to the external DHCP server 40 (1610), and this routine is ended.

When it is determined in step 1607 that the received packet is not the DHCP Discover, which means that the received packet is not the DHCP packet but a normal packet, so the packet processing section 210 transfers the received packet (1611), and this routine is ended.

As described above, according to the present embodiment, when the wireless AP 10 is replaced with a new wireless AP 10, the packet relay device 20 in which the function of the DHCP server 40 is implemented transmits, to the new wireless AP 10, the DHCP ACK corresponding to the DHCP request transmitted from the new wireless AP 10, including therein the wireless AP name of the new wireless AP 10 and IP address of the management server 30. Thus, even when the wireless AP 10 is replaced with a new wireless AP 10, it is possible to acquire the setting information of the new wireless AP 10 from the management server 30 only by connecting the new wireless AP 10 to the packet relay device 20, thereby allowing initial setting of the new wireless AP 10 to be automatically performed without manual intervention.

In the above first to third embodiments, the wireless AP 10 is used as an example of a node for acquiring the setting information; however, the node for acquiring the setting information is not limited to the wireless AP 10. For example, the node may be a monitoring camera. In this case, the setting information to be stored in the management server 30 includes, e.g., a resolution of the monitoring camera, an imaging thereof, and the like.

Further, in the above first to third embodiments, the IP address is distributed to the node by using the DHCP; however, the IP address may be distributed using any other protocols.

Further, the network system according to the present invention is not limited to that illustrated in FIG. 1 but may have any configuration. The number of the packet relay devices 20, number of lines for connecting the devices, etc., may be arbitrarily selected. Further, a path for exchanging data among the devices may be arbitrarily constructed.

The present invention is not limited to the above-described embodiments and includes various modifications. For example, the above embodiments are detailed to make the present invention easily understood and are not limited to an embodiment having all the explained constitutions. Part of the constitution of a certain embodiment may be substituted by the constitution of another embodiment, and the constitution of another embodiment may be added to the constitution of a certain embodiment. The addition, deletion or substitution of another constitution may be carried out on part of the constitution of an embodiment.

In addition, each configuration, function, processing section, processing means, and the like in the above embodiments may be realized in hardware, for example, by designing some or all of them using integrated circuits. Further, each configuration, function, and the like may be realized in software by a processor analyzing and executing a program for realizing each function. Information such as a program, a table, or a file for realizing each function may be stored in a recording device such as a memory, a hard disk, an SSD (Solid State Drive), or a recording medium such as an IC card, an SD card, or a DVD.

What is claimed is:

1. A relay device connected to a node comprising: at least one physical port connected to the node and a processor,
when receiving an address acquisition request which is a request for acquiring an address to be set in the node from the node through the physical port, the processor transmits, to the node, an address acquisition reply including the address to be set in the node, node information identifying the node that has transmitted the address acquisition request, and an address of the setting information storage device that stores setting information of the node through the network, transmits, to the setting information storage device, a setting information acquisition request which is a request that the node has transmitted to acquire setting information of the node and which includes the node information with the address of the setting information storage device set as a destination, and transmits, to the node, setting information which corresponds to the node information included in the setting information acquisition request and which is transmitted from the setting information storage device.

2. The relay device according to claim 1, wherein
the node information is associated with identification information of the physical port, and
the processor transmits, to the node, the address acquisition reply including the node information corresponding to the identification information of the physical port through which the address acquisition request is received.

3. The relay device according to claim 1, wherein
the node information is information indicating a position at which the node is installed.

4. The relay device according to claim 1, wherein
the relay device is connected, through the network, to an address distribution device that distributes the address to be set in the node and retains node information registration information including a correspondence between the identification information of the physical port and the node information,
when receiving the address acquisition request, the processor identifies the physical port through which the address acquisition request is received and transmits the received address acquisition request to the address distribution device, and
when receiving, from the address distribution device, the address acquisition reply including the address to be set in the node, the processor refers to the node information registration information and acquires the node information corresponding to the identification information of the physical port through which the address acquisition request is received and transmits, to the node, the received acquisition rely, including therein the acquired node information and the address of the setting information storage device.

5. The relay device according to claim 1, wherein
the relay device is connected, through the network, to an address distribution device that distributes the address to be set in the node,
when receiving the address acquisition request, the processor identifies the physical port through which the address acquisition request is received and transmits, to the address distribution device, the received address acquisition request, including therein the identification information of the identified physical port, and
when receiving, from the address distribution device, the address acquisition reply including the address to be set in the node, node information corresponding to the identification information of the physical port included in the address acquisition request, and address of the setting information storage device, the processor transmits the address acquisition reply to the node.

6. The relay device according to claim 1, further comprises a memory coupled to the processor wherein
the processor retains, to the memory, node information registration information including a correspondence between the identification information of the physical port and the node information, and
when receiving the address acquisition request, the processor identifies the physical port through which the address acquisition request is received, acquires the node information corresponding to the identification information of the identified physical port by referring to the node information registration information, and transmits, to the node, an address acquisition reply including the address to be set in the node, acquired node information, and address of the setting information storage device.

7. A communication system comprising:
a node; and
a relay device that connects the node to a network, wherein
the relay device has at least one physical port connected to the node,
the node is configured to transmit an address acquisition request which is a request for acquiring an address thereof,
when the relay device receives the address acquisition request from the node through the physical port, the relay device transmits, to the node, an address acquisition reply including the address to be set in the node, node information identifying the node that has transmitted the address acquisition request, and an address of a setting information storage device which is connected to the network and configured to store setting information of the node,
when the node receives the address acquisition reply from the relay device, the node sets the address therein based on the received address acquisition reply and transmits, to the relay device, a setting information acquisition request which is a request for acquiring the setting information of the node and which includes the node information included in the received address acquisition reply with the address of the setting information storage device included in the received address acquisition reply set as a destination,
when the relay device receives the setting information acquisition request from the node, the relay device transmits the received setting information acquisition request to the setting information storage device and, when receiving, from the setting information storage device, the setting information corresponding to the node information included in the setting information acquisition request, transmits the received setting information to the node, and
when the node receives the setting information from the relay device, the node executes setting processing therefor based on the received setting information.

8. The communication system according to claim 7, wherein
the node information is associated with identification information of the physical port, and
the processor device transmits, to the node, the address acquisition reply including the node information corresponding to the identification information of the physical port through which the address acquisition request is received.

9. The communication system according to claim 7, wherein
the node information is information indicating a position at which the node is installed.

10. The communication system according to claim 7, wherein
the relay device is connected, through the network, to an address distribution device that distributes the address to be set in the node and retains node information registration information including a correspondence between the identification information of the physical port and the node information,
when the relay device receives the address acquisition request, the relay device identifies the physical port through which the address acquisition request is received and transmits the received address acquisition request to the address distribution device,
when the address distribution device receives the address acquisition request, the address distribution device transmits, to the relay device, the address acquisition reply including the address to be set in the node, and
when the relay device receives the address acquisition reply from the address distribution device, the relay device refers to the node information registration information and acquires the node information corresponding to the identification information of the physical port through which the address acquisition request is received and transmits, to the node, the received acquisition rely, including therein the acquired node information and the address of the setting information storage device.

11. The communication system according to claim 7, wherein
the relay device is connected, through the network, to an address distribution device that distributes the address to be set in the node,
the address distribution device retains node information registration information including a correspondence between the identification information of the physical port and node information,
when the relay device receives the address acquisition request from the node, the relay device identifies the physical port through which the address acquisition request is received and transmits, to the address distribution device, the received address acquisition request, including therein the identification information of the identified physical port,
when the address distribution device receives the address acquisition request from the relay device, the address distribution device acquires the node information corresponding to the identification information of the physical port included in the address acquisition request by referring to the node information registration information and transmits, to the relay device, the address acquisition reply including the address to be set in the node, acquired node information, and address of the setting information storage device, and
when the relay device receives the address acquisition reply from the address distribution device, the relay device transmits the received address acquisition reply to the node.

12. The communication system according to claim 7, wherein
the relay device retains node information registration information including a correspondence between the identification information of the physical port and the node information and, when receiving the address acquisition request from the node, identifies the physical port through which the address acquisition request is received, acquires the node information corresponding to the identification information of the identified physical port by referring to the node information registration information, and transmits, to the node, an address acquisition reply including the address to be set in the node, acquired node information, and address of the setting information storage device.

13. A method of acquiring setting information of a node in a communication system including the node and a relay device that connects the node to a network,
the relay device being connected to a setting information storage device that stores setting information of the node through the network and having at least one physical port connected to the node, the method comprising the steps of:
transmitting by the node, an address acquisition request which is a request for acquiring an address thereof;
when the relay device receives the address acquisition request from the node through the physical port, transmitting, by the relay device, to the node, an address acquisition reply including the address to be set in the node, node information identifying the node that has transmitted the address acquisition request, and an address of the setting information storage device connected to the network;
when the node receives the address acquisition reply from the relay device, setting, by the node, the address therein based on the received address acquisition reply and transmitting, by the node, to the relay device, a setting information acquisition request which is a request for acquiring the setting information of the node and which includes the node information included in the received address acquisition reply with the address of the setting information storage device included in the received address acquisition reply set as a destination,
when the relay device receives the setting information acquisition request from the node, transmitting, by the relay device, the received setting information acquisition request to the setting information storage device and, when receiving, from the setting information storage device, the setting information corresponding to the node information included in the setting information acquisition request, transmitting, by the relay device, the received setting information to the node, and
when the node receives the setting information from the relay device, executing, by the node, setting process of the node based on the received setting information.
